(19) United States
(12) Patent Application Publication
(10) Pub. No.: US 2021/0001591 A1
(43) Pub. Date: Jan. 7, 2021

(54) MOLDED PART AND METHOD FOR PRODUCING SUCH A MOLDED PART

(71) Applicant: NOVEM Car Interior Design GmbH, Vorbach (DE)

(72) Inventors: Alexander MARTIN, Pommelsbrunn (DE); Mario HAAS, Ahorntal (DE)

(21) Appl. No.: 16/981,184

(22) PCT Filed: Mar. 12, 2019
(86) PCT No.: PCT/EP2019/056187

§ 371 Date: Sep. 15, 2020

(30) Foreign Application Priority Data
Mar. 16, 2018 (DE) 10 2018 106 258.3

(51) Int. Cl. B32B 3/26; B32B 5/02; B32B 7/12; B32B 21/10; B32B 21/14; B32B 37/12; B32B 37/15

(52) U.S. Cl. CPC B32B 3/266; B32B 5/022; B32B 7/12; B32B 21/10; B32B 21/14; B32B 37/12; B32B 2605/08; B32B 2255/02; B32B 2255/08; B32B 2255/26; B32B 2307/40; B32B 2451/00; B32B 2605/003; B32B 37/153

(57) ABSTRACT

A molded part comprises a decorative layer having on its front side a decorative ply of a wood veneer, wherein: a grain structure of the wood veneer is visible on the front side thereof, the grain structure has light regions and dark regions, a large number of light passages are provided in the decorative layer, and the light passages extend through the decorative layer; a translucent carrier; a light element comprising a light source and light passages arranged to imitate the grain structure of the wood veneer on the front side of the decorative ply, such that the density of the light passages in the decorative layer is dependent on the grain structure on the front side of the wood veneer, whereby, in the dark regions of the grain structure, there is a higher density or lower density of light passages than in the light regions of the grain structure.

The invention relates to a molded part, in particular a decorative part and/or panel part designed as a molded part for a vehicle interior. The invention further relates to a method for producing such a molded part.

Numerous decorative and panel parts are installed in the vehicle interior, for example door panels, console panels, and instrument panels. The decorative and panel parts also include control buttons and their covers.

The requirements placed on such molded parts are constantly increasing. In particular, lighting effects for improving the visibility of the decor of the molded parts are desired, which make the decor visible even in poor or dimmed light conditions in order to visually enhance the molded part and thus the vehicle interior.

With high-quality wood veneers as the decorative ply of the molded part, there is in particular the requirement to make the grain structure of the wood veneer recognizable even in poor or dimmed light conditions.

Furthermore, there is a requirement for such molded parts that no changes or special features can be seen on the surface of the molded part in good light conditions. In this case, the viewer should only be able to see the conventional surface of the decor.

The invention is therefore based on the object of specifying a new molded part, in particular a molded part in which the grain structure of the wood veneer can be seen even in poor or dimmed light conditions. Furthermore, the object of the invention is to provide a method for producing such a molded part.

This object is achieved in terms of the molded part by the features of claim 1 and in terms of the method by features of claim 6. Advantageous refinements and developments are specified in the respective dependent claims.

The molded part according to the invention comprises a, preferably at least partially opaque, decorative layer having a front side designed as a visible side and a rear side opposite the front side, the front side of the decorative layer comprising a decorative ply formed from a wood veneer, wherein a grain structure of the wood veneer is visible on the front side of the decorative ply, wherein the grain structure has light regions and dark regions.

A large number of light passages for the transmission of light from the rear side of the decorative layer to the front side of the decorative layer which is designed as a visible side are provided in the decorative layer, wherein the light passages extend through the decorative layer.

The molded part further comprises a transparent or translucent carrier, the carrier being provided on the rear side of the decorative layer.

Furthermore, the molded part comprises a light element comprising a light source, the light element being provided for illuminating the light passages, and the light element being provided on a rear side of the carrier.

The light passages are arranged to imitate the grain structure of the wood veneer on the front of the decorative ply in such a way that the density of the light passages in the decorative layer is dependent on the grain structure on the front side of the wood veneer, such that a higher density or a lower density of light passages is provided in the dark regions of the grain structure than in the light regions of the grain structure.

The density of the light passages is understood to mean in particular the distribution density of the light passages in a plan view of the front side of the decorative ply.

The dark regions and/or the light regions are predetermined or conditioned in particular by the grain structure, preferably the different colors or color intensities of the grain structure. Dark and light regions can also have different color intensities in their group. In particular, dark and light regions alternate at least in sections.

It can also be provided that only part of the grain structure has light and dark regions.

Light regions of the grain structure can be made lighter than the dark regions of the grain structure due to a higher density of light passages.

It is also possible that the grain structure is reproduced inversely, in that the dark regions of the grain structure are shown lighter than the—actually—light regions of the grain structure by means of a higher density of light passages, in the case of operation, i.e. when the light source is switched on.

The light passages preferably have such a small diameter that they are difficult or impossible to see for a viewer in the event of a malfunction, i.e. when the light source is switched off.

The main advantage of the invention is, in particular, that when the light source is switched on, the grain structure of the wood veneer is recognizable or at least partially reproduced even in poor or dimmed light conditions, whereas when the light source is switched off, no abnormalities of the surface of the molded part can be seen.

It can be provided that a predetermined density of light passages is provided in the light regions, whereas no light passages are provided in the dark regions.

Alternatively, it can be provided that a predetermined density of light passages is provided in the dark regions, whereas no light passages are provided in the light regions.

According to an embodiment variant of the invention, the light passages are provided in the regions with higher density and/or in the regions with low density of light passages in each case in edge portions or predominantly in the edge portions of these regions.

A further development of the invention provides that a plurality of dark regions and/or a plurality of light regions of the grain structure each have a different density of light passages.

A preferred embodiment variant of the invention provides that the decorative layer comprises a non-woven or fabric layer attached, in particular glued, to the rear side of the decorative ply by means of an adhesive layer.

The light element is preferably or comprises a flat illuminant. The light element preferably extends over the entire rear side of the carrier. It can also be provided that the light element is provided in particular in the region of the light passages on the rear side of the carrier.

A protective and/or optical layer can be provided on the front side of the decorative layer, the protective and/or optical layer preferably comprising a lacquer layer or being formed from a lacquer layer. The protective and/or optical layer can be sprayed on or poured on.

The method according to the invention for producing a molded part according to the invention comprises the steps:

providing a wood veneer intended to form the decorative ply;

detecting the grain structure of the wood veneer, in particular from the front side of the decorative ply;

determining dark regions and light regions of the grain structure;

introducing light passages into the decorative layer, in particular by lasers, wherein the light passages are arranged to imitate the grain structure of the wood veneer on the front of the decorative ply in such a way that the density of the light passages in the decorative layer is dependent on the grain structure on the front side of the wood veneer, such that a higher density or a lower density of light passages is provided in the dark regions of the grain structure than in the light regions of the grain structure;

injection molding the decorative layer with a transparent or translucent carrier material to form the carrier;

curing the carrier material;

providing the light element on the rear side of the carrier.

The method step “determining dark regions and light regions” can be understood in terms of defining and/or recognizing the dark or light regions.

According to a further development of the method, it is provided that a predetermined density of light passages is provided, in particular introduced, in the bright regions, whereas no light passages are provided, in particular introduced, in the dark regions.

Alternatively, it can be provided that a predetermined density of light passages is provided, in particular introduced, in the dark regions, whereas no light passages are provided, in particular introduced, in the light regions.

According to one embodiment variant, the light passages are provided, in particular introduced, in the regions with higher density and/or in the regions with low density of light passages in edge portions or predominantly in the edge portions of these regions.

It can be provided that a different density of light passages in the dark regions and/or the light regions is provided, in particular introduced.

Furthermore, it can be provided that after the provision of the decorative ply by means of an adhesive layer, a non-woven or fabric layer is attached, in particular glued, to the rear side of the decorative ply.

The invention is also explained in more detail below with regard to further features and advantages on the basis of the description of the exemplary embodiments and with reference to the accompanying schematic drawings. In the figures:

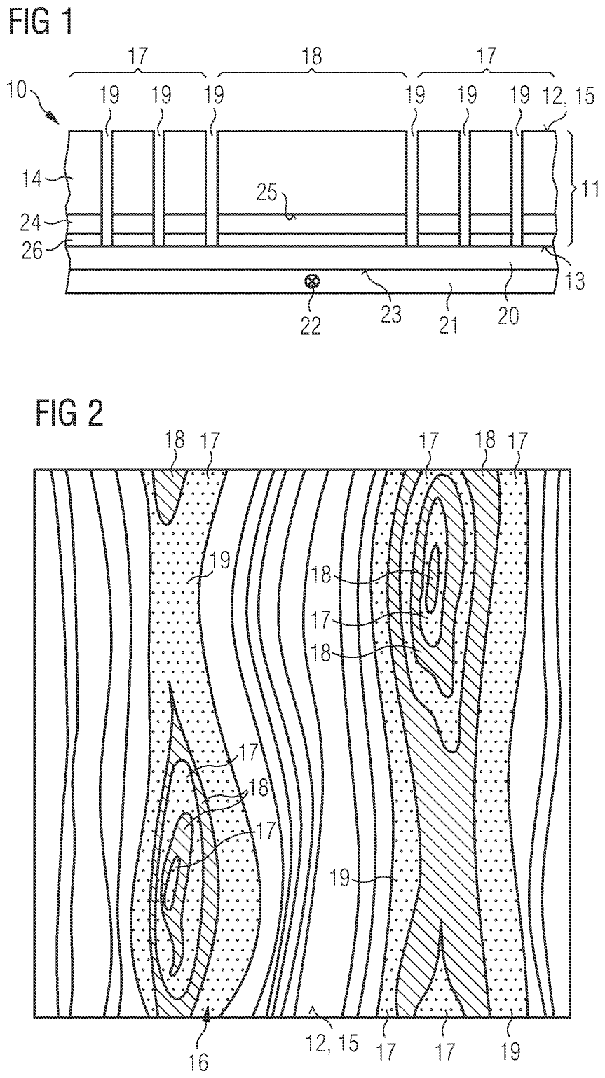

FIG. 1 is a schematic cross-sectional representation of an enlarged section of a further exemplary embodiment of a molded part according to the invention,

FIG. 2 is a schematic representation of a plan view of a section of the front side of the wood veneer of an exemplary embodiment of a molded part according to the invention.

Corresponding parts and components, even across the various exemplary embodiments, are each identified by the same reference symbols.

FIG. 1 shows a molded part 10, comprising an at least partially opaque decorative layer 11 having a front side 12 designed as a visible side and a rear side 13 opposite the front side 12.

The decorative layer 11 comprises on its front side 12 a decorative ply 14 formed from a wood veneer, a grain structure 16 of the wood veneer being visible on the front 15 of the decorative ply 14, the grain structure 16 having light regions 17 and dark regions 18. The grain structure 16 as well as the light regions 17 and the dark regions 18 can particularly be seen in FIG. 2.

In the decorative layer 11, a plurality of light passages 19 are provided for the transmission of light from the rear side 13 of the decorative ply 11 to the front side 12 of the decorative ply 11 designed as a visible side, wherein the light passages 19, as shown in FIG. 1, extend through the decorative layer 11.

The molded part 10 further comprises a transparent or translucent carrier 20, the carrier 20 being molded onto the rear side 13 of the decorative layer 11.

Furthermore, the molded part 10 comprises a light element 21 comprising at least one light source 22, wherein the light element 21 is provided for illuminating the light passages 19, and the light element 19 is provided on a rear side 23 of the carrier 20.

The light passages 19 are used to imitate the grain structure 16, as illustrated in FIG. 2, the wood veneer is arranged on the front side 15 of the decorative ply 14 such that the density of the light passages 19 in the decorative layer 11 is dependent on the grain structure 16 on the front side 15 of the wood veneer, such that, in the dark regions 18 of the grain structure 16, a lower density of light passages 19 is provided than in the light regions 17 of the grain structure 16.

According to the exemplary embodiments of FIG. 1 and FIG. 2, a predetermined density of light passages 19 is provided in the light regions 17, whereas no light passages 19 are provided in the dark regions 18.

The light regions 17 of the grain structure 16 according to the exemplary embodiment according to FIG. 2 each have a different density of light passages 19.

In addition to the decorative ply 14, the decorative layer 11 comprises a non-woven layer 26 adhered to the rear side 25 of the decorative ply 14 by means of an adhesive layer 24.

A method for producing the molded part 10 according to the invention according to the exemplary embodiment is specified according to FIG. 1. This method includes the steps:

providing a wood veneer intended to form the decorative ply 14;

gluing a non-woven layer 26 by means of an adhesive layer 24 to the rear side 23 of the decorative ply 14;

detecting the grain structure 16 of the wood veneer from the front side 15 of the decorative ply 14;

determining dark regions 18 and light regions 17 of the grain structure 16;

introducing light passages 19 into the decorative layer 11 by lasers, wherein the light passages 19 are arranged so as to imitate the grain structure 16 of the wood veneer on the front side 15 of the decorative ply 14 such that the density of the light passages 19 in the decorative layer 11 is dependent on the grain structure 16 on the front side 15 of the wood veneer, such that, in the dark regions 18 of the grain structure, a lower density of light passages 19 is provided than in the light regions 17 of the grain structure 16;

injection molding of the decorative layer 11 with a transparent or translucent carrier material to form the carrier 20;

curing the carrier material;

providing the light element 21 on the rear side 23 of the carrier 20.

A predetermined density of light passages 19 is introduced in the light regions 17, whereas no light passages 19 are provided in the dark regions 18.

A plurality of dark regions 18 and a plurality of light regions 17 of the grain structure 16 are provided, with a different density of light passages 19 being introduced into the various light regions 17.

### LIST OF REFERENCE NUMBERS

10 molded part
11 decorative layer
12 front side
13 rear side
14 decorative ply
15 front side
16 grain structure
17 light regions
18 dark regions
19 light passages
20 carrier
21 light element
22 light source
23 rear side
24 adhesive layer
25 rear side
26 non-woven or fabric layer

1-10. (canceled)

11. A molded part comprising:
a decorative layer having a front side designed as a visible side and a rear side opposite the front side, wherein the decorative layer comprises on its front side a decorative ply formed from wood veneer, wherein a grain structure of the wood veneer is visible on the front side of the decorative ply, wherein the grain structure has light regions and dark regions,
wherein a plurality of light passages for transmitting light from the rear side of the decorative layer to the front side of the decorative layer being designed as the visible side, is provided in the decorative layer, wherein the light passages extend through the decorative layer,
a transparent or translucent carrier, wherein the carrier is provided on the rear side of the decorative layer,
a light element comprising at least one light source, wherein the light element is provided for illuminating the light passages, and the light element is provided on a rear side of the carrier,
wherein the light passages are arranged so as to imitate the grain structure of the wood veneer on the front side of the decorative ply such that the density of the light passages in the decorative layer is dependent on the grain structure on the front side of the wood veneer, such that, in the dark regions of the grain structure, a higher density or lower density of light passages is provided than in the light regions of the grain structure.

12. The molded part according to claim 11, wherein:
a predetermined density of light passages is provided in the light regions, whereas no light passages are provided in the dark regions, or
a predetermined density of light passages is provided in the dark regions, whereas no light passages are provided in the light regions.

13. The molded part according to claim 11, wherein:
the light passages in the regions with higher density and/or in the regions with low density of light passages are each provided in edge portions of these regions or predominantly in the edge portions.

14. The molded part according to claim 11, wherein:
a plurality of dark regions and/or a plurality of light regions of the grain structure each have a different density of light passages.

15. The molded part according to claim 11, wherein:
the decorative layer comprises a non-woven or fabric layer attached to the rear side of the decorative ply by means of an adhesive layer.

16. The method for producing a molded part according to one of the preceding claims, comprising the steps:
providing a wood veneer intended to form the decorative ply;
detecting the grain structure of the wood veneer;
determining dark regions and light regions of the grain structure;
introducing light passages into the decorative layer, wherein the light passages are arranged so as to imitate the grain structure of the wood veneer on the front side of the decorative ply such that the density of the light passages in the decorative layer is dependent on the grain structure on the front side of the wood veneer, such that, in the dark regions of the grain structure, a higher density or lower density of light passages is provided than in the light regions of the grain structure;
injection molding of the decorative layer with a transparent or translucent carrier material to form the carrier;
curing the carrier material;
providing the light element on the rear side of the carrier.

17. The method according to claim 16, wherein:
a predetermined density of light passages is provided in the light regions, whereas no light passages are provided in the dark regions, or
a predetermined density of light passages is provided in the dark regions, whereas no light passages are provided in the light regions.

18. The method according to claim 16, wherein:
the light passages in the regions with higher density and/or in the regions with low density of light passages are provided in edge portions or predominantly in the edge portions of these regions.

19. The method according to claim 16, wherein:
a different density of light passages is provided in the dark regions and/or the light regions.

20. The method according to claim 16, wherein:
after the decorative ply has been provided, a non-woven or fabric layer is attached to the rear side of the decorative ply by means of an adhesive layer.
